(19) United States
(12) Patent Application Publication
(10) Pub. No.: US 2024/0056269 A1
(43) Pub. Date: Feb. 15, 2024

(54) INDICATING SUBBAND CONFIGURATIONS BETWEEN NETWORK ENTITIES

(71) Applicant: QUALCOMM Incorporated, San Diego, CA (US)

(72) Inventors: Qian ZHANG, Basking Ridge, NJ (US); Yan ZHOU, San Diego, CA (US); Muhammad Sayed Khairy ABDELGHAFFAR, San Jose, CA (US)

(21) Appl. No.: 17/887,398

(22) Filed: Aug. 12, 2022

(51) Int. Cl. H04L 5/00; H04W 72/08

(52) U.S. Cl. CPC H04L 5/0092; H04L 5/0062; H04W 72/082; H04L 5/14

(57) ABSTRACT

Certain aspects of the present disclosure provide techniques for indicating subband configurations between network entities. An example method that may be performed by a network entity includes receiving an indication of at least one of time or frequency locations of at least one uplink (UL) subband or at least one downlink (DL) subband for a cell operating with subband full duplex (SBFD) communications or subband half duplex communications; and performing interference mitigation (IM) while receiving an UL transmission, based on the indication.

### BACKGROUND

### Field of the Disclosure

Aspects of the present disclosure relate to wireless communications, and more particularly, to techniques for indicating subband configurations between network entities.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a network entity. The method includes receiving an indication of at least one of time or frequency locations of at least one uplink (UL) subband or at least one downlink (DL) subband for a cell operating with subband full duplex (SBFD) communications or subband half duplex communications; and performing interference mitigation (IM) while receiving an UL transmission, based on the indication.

Another aspect provides a method for wireless communications by a user equipment (UE). The method includes receiving a configuration of at least one of time or frequency locations of at least one UL subband or at least one DL subband for a neighbor cell operating with SBFD communications or subband half duplex communications; and transmitting an indication of the configuration to a network entity serving the UE.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example subband configuration of a component carrier during a slot, in accordance with aspects of the present disclosure.

FIG. 6 depicts in block form a network entity operating in full duplex mode, according to aspects of the present disclosure.

FIG. 7 depicts in block form a gNB and two UEs performing subband full duplex (SBFD) operations, according to aspects of the present disclosure.

FIG. 8 is a schematic depiction of cross-link interference, in accordance with aspects of the present disclosure.

FIG. 9A depicts an example call flow for communications in a network between a first network entity and a second network entity, in accordance with aspects of the present disclosure.

FIG. 9B depicts an example call flow for communications in a network between a first network entity, a second network entity, and a UE 904, in accordance with aspects of the present disclosure

FIGS. 10A, 10B, 10C, and 10D depict example subband frequency configuration patterns, in accordance with aspects of the present disclosure.

FIGS. 11A and 11B depict examples of network entities and UEs operating with SBFD communications, in accordance with aspects of the present disclosure.

FIGS. 12A and 12B depict an example of two network entities and two UEs operating with subband half duplex communications, in accordance with aspects of the present disclosure.

FIG. 13 depicts a method for wireless communications.

FIG. 14 depicts a method for wireless communications.

FIG. 15 depicts aspects of an example communications device.

FIG. 16 depicts aspects of an example communications device.

### DETAILED DESCRIPTION

Aspects of the present disclosure provide apparatuses, methods, processing systems, and computer-readable mediums for indicating subband configurations between network entities.

In typical communications networks, network entities do not exchange information regarding the subband configurations of cells supported by those network entities. Thus, when using subband full duplex (SBFD) or subband half duplex communications, the cells may select different subband configurations. When cells that neighbor each other use different subband configurations, cross-link interference (CLI) may be caused by the neighboring scheduling uplink and downlink communications on the same frequency resources at the same time.

According to aspects of the present disclosure, techniques are provided for indicating subband configurations between network entities. The network entities may send (e.g., via backhaul, midhaul, or fronthaul signaling or over-the-air signaling) indications of the subband configurations being used in cells operated by the network entities. Network entities receiving the indications may use the information in performing interference mitigation while receiving signals.

By sharing information regarding subband configurations of neighboring cells, network entities may improve their ability to perform interference mitigation of CLI. Improving the interference mitigation may improve both throughput and reliability of communications in wireless networks. Ultra-reliable low latency communications (URLLC), which may use SBFD communications extensively, may especially benefit from indicating subband configurations between network entities.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

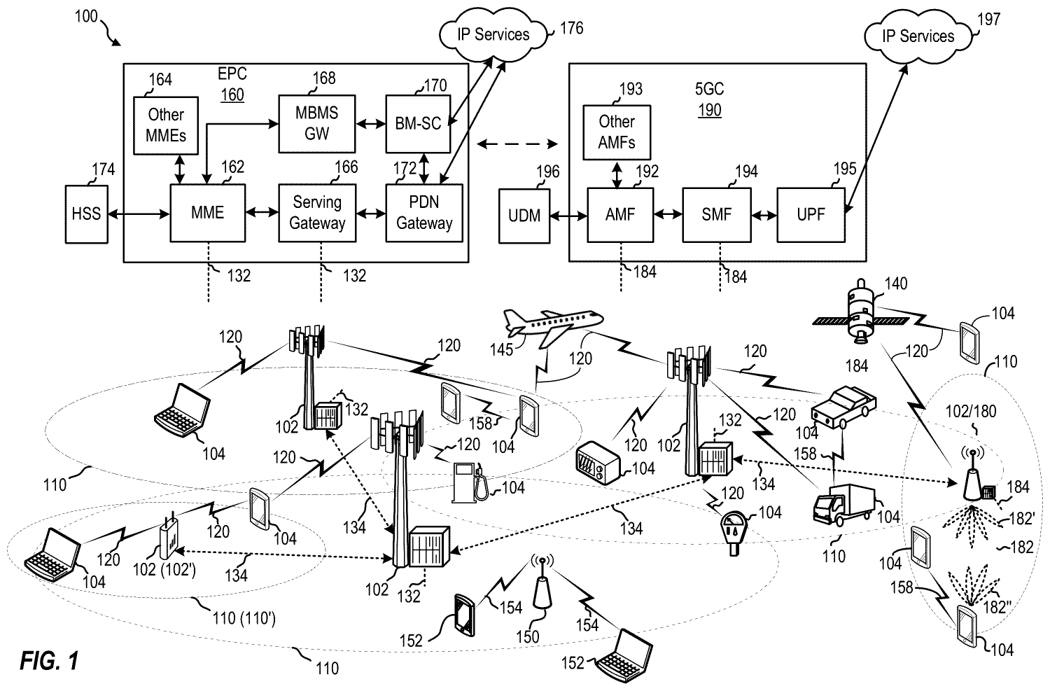

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

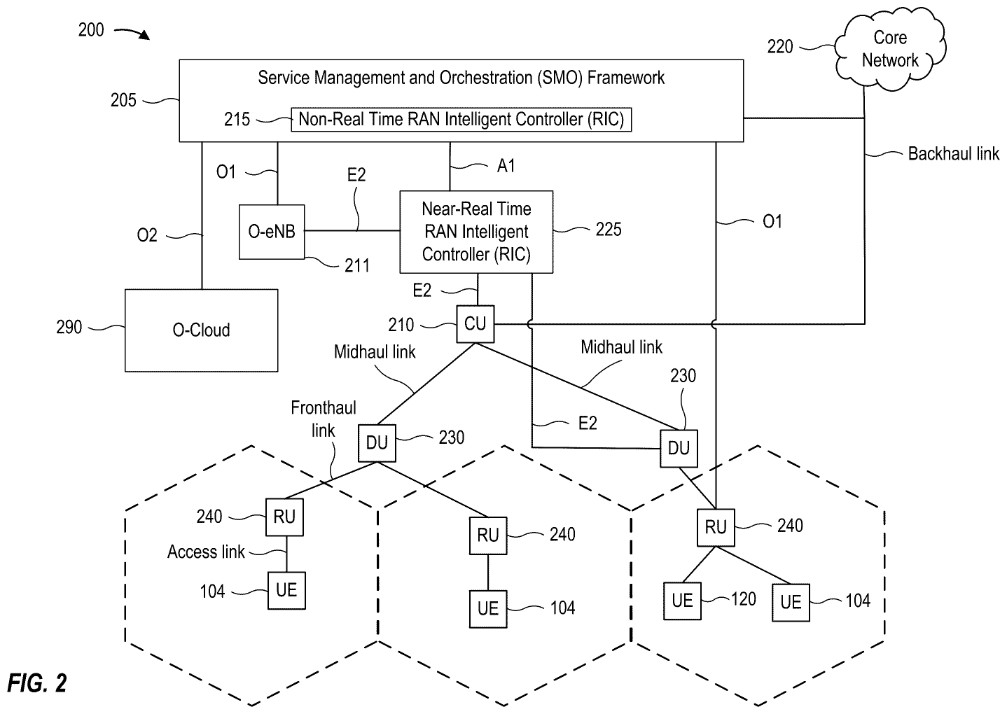

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an Si interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

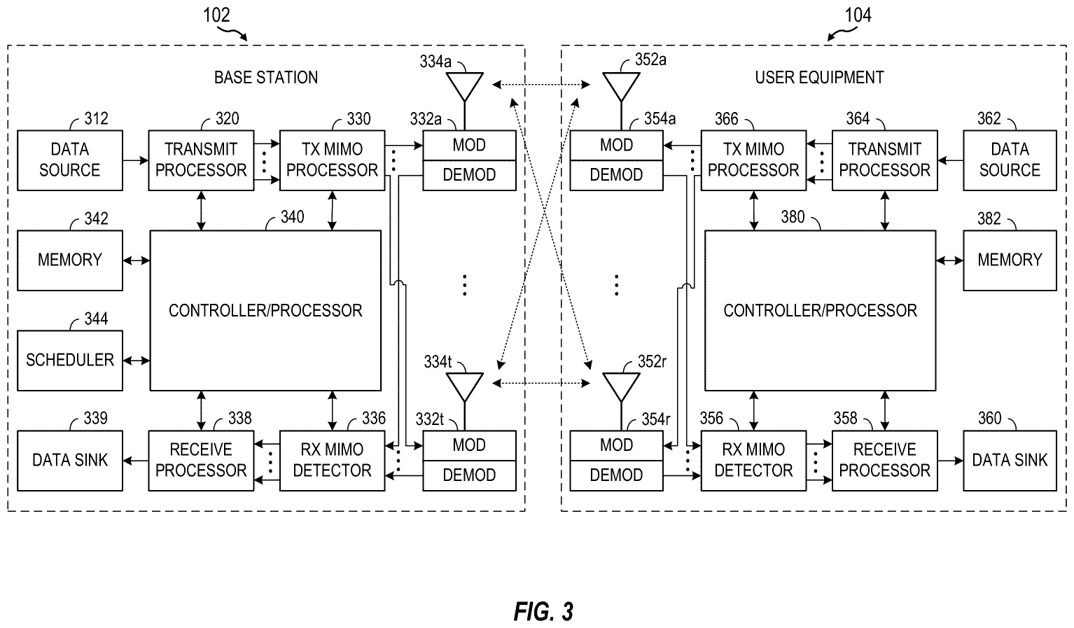

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

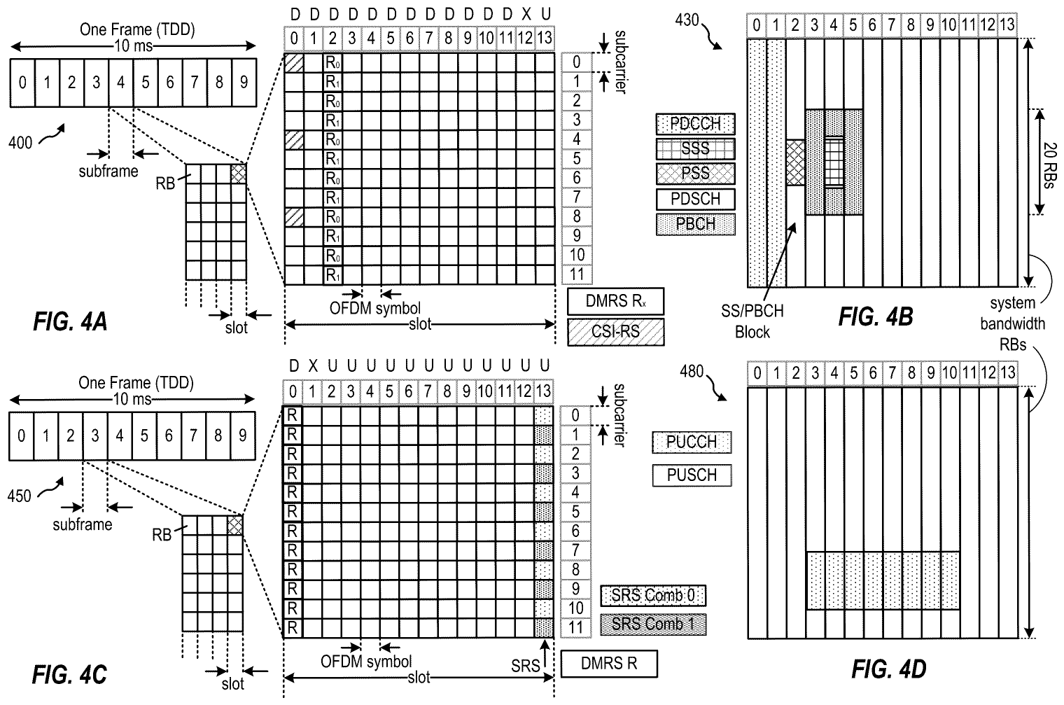

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of sub carriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Indicating Subband Configurations in Subband Full Duplex Operation

In typical cellular communications systems operating using time domain duplexing (TDD), the network (e.g., a network entity, such as a BS or a node of a disaggregated BS) may indicate to the UEs a TDD UL/DL configuration of transmit directions for slots or subframes of a frame. Such a TDD UL/DL configuration may be broadcast in a SystemInformationBlockType1 (SIB1) in a cell and may have a form similar to DDDDDDDFUU, where each “D” indicates a slot that is for DL transmissions, each “U” indicates a slot that is for UL transmissions, and each “F” indicates a flexible slot that may be dynamically switched between being used for UL transmissions and DL transmissions.

Changing a TDD UL/DL configuration in a cell is typically done by broadcasting a SIB1 with the new TDD UL/DL configuration in the cell. Broadcasting a SIB1 having a changed TDD UL/DL configuration typically involves paging all UEs in the cell to notify the UEs of the change, and thus takes some time to accomplish.

In aspects of the present disclosure, a cell may operate using subband full duplex (SBFD) communications, in which a network entity uses some antennas to transmit one or more DL signals via one or more subbands of a component carrier (CC) to one or more UEs while simultaneously using other antennas to receive UL signals via other subbands of the CC from other UEs. SBFD communications may increase an UL duty cycle in the cell for at least some UEs, which may lead to a latency reduction because UEs may be able to receive DL signals in UL-only slots and lead to an UL coverage improvement. In addition, SBFD may enhance system capacity, resource utilization, and/or spectrum efficiency. SBFD may also enable flexible and dynamic UL/DL resource adaption according to UL and DL traffic in the cell in a robust manner.

According to aspects of the present disclosure, a cell may operate using subband half duplex communications, in which a network entity, during a slot or symbol, either transmits one or more DL signals via one or more subbands of a component carrier (CC) to one or more UEs or receives UL signals via other subbands of the CC from the UEs. Subband half duplex communications may increase an UL duty cycle in the cell for at least some UEs, which may lead to a latency reduction because UEs may be able to receive DL signals in UL-only slots and lead to an UL coverage improvement. In addition, cells operating using subband half duplex communications may avoid causing cross-link interference (CLI) that can be associated with SBFD communications. For example, if a cell only receives UL transmissions on a subband during a slot or symbol, then that cell does not transmit DL signals that may cause CLI for a neighbor cell receiving UL transmissions during the slot or symbol. In another example, if a cell only transmits DL transmissions on a subband during a slot or symbol, then that cell does not schedule any UEs to transmit UL signals that may cause CLI for other UEs in the cell receiving the DL transmissions during the slot or symbol.

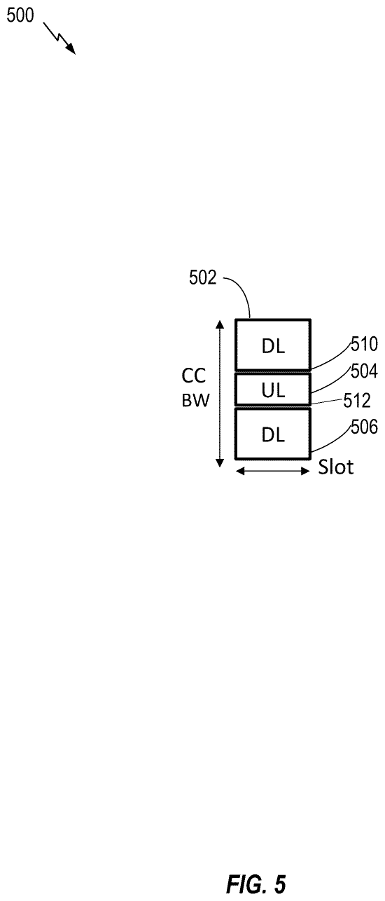

FIG. 5 depicts an example subband configuration 500 of a component carrier during a slot, in accordance with aspects of the present disclosure. In the example subband configuration, an UL subband 504 is configured between two DL subbands 502 and 506. Guard bands (GBs) 510 and 512 separate the UL subband from each of the two DL subbands.

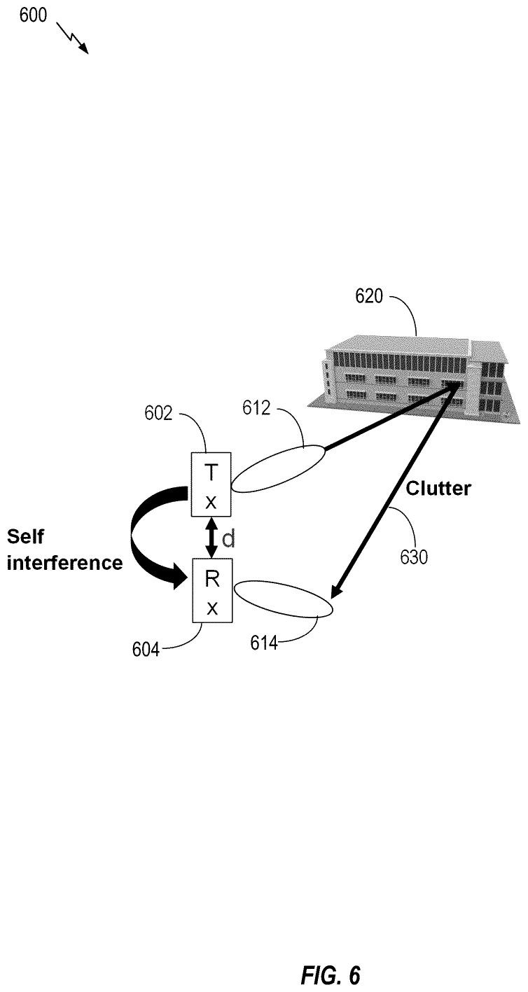

FIG. 6 depicts in block form a network entity (e.g., BS 102) operating in full duplex mode, according to aspects of the present disclosure. As illustrated, a first antenna 602 of the network entity transmits a signal using a first beam 612 while a second antenna 604 of the network entity receives another signal using a second beam 614. The first antenna may be separated from the second antenna by a distance d. The signal from the first antenna may be directly received by the second antenna, resulting in self interference with the other signal being received by the second antenna. In addition, the first signal may reflect from an object 620 in the environment, and the reflected signal may also be received by the second antenna, resulting in clutter 630 affecting reception of the other signal by the second antenna. Both the self interference and the clutter may be at least partially mitigated by causing the transmitted signal from the first antenna to be on a different subband from the signal being received by the second antenna.

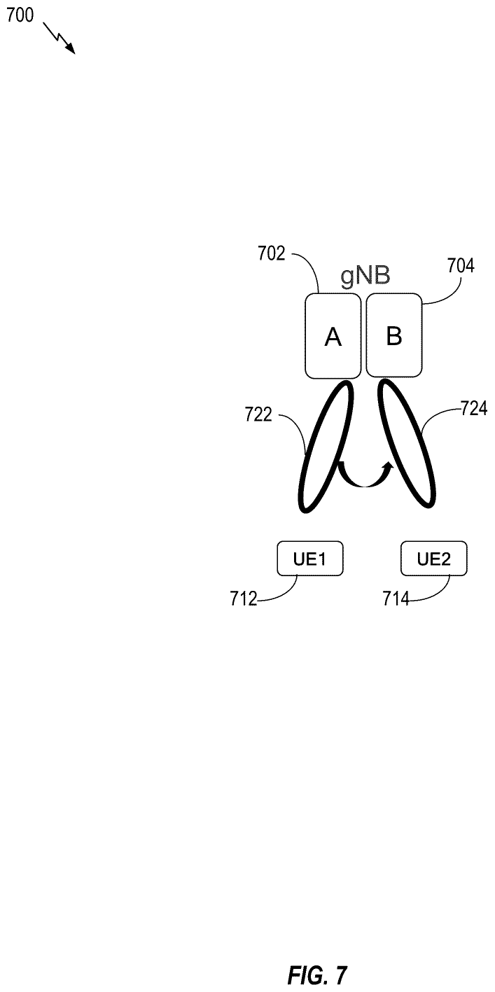

FIG. 7 depicts in block form a gNB and two UEs 712 and 714 performing SBFD operations, according to aspects of the present disclosure. As illustrated, a first antenna 702 of the gNB transmits a signal to the UE 712 on a first subband using a first beam 722 while a second antenna 704 of the network entity receives another signal from the UE 714 on a second subband using a second beam 724. As illustrated, the first signal may interfere with reception of the second signal by the second antenna.

When a network entity is operating using SBFD communications, the network entity may experience interference while receiving an UL signal caused by another network entity simultaneously transmitting a DL signal in a same or adjacent channel as the UL signal. Similarly, when a UE is operating using SBFD communications, the UE may experience interference while receiving a DL signal caused by another UE simultaneously transmitting an UL signal in a same or adjacent channel as the DL signal. In general, interference caused by another device transmitting in a different direction is referred to as cross-link interference (CLI). CLI is typically characterized as either co-channel or adjacent channel.

Typically, co-channel interference refers to interference is from an aggressor to a victim due to a transmission in the same carrier as the signal the victim is attempting to receive. Co-channel intra-subband interference refers to interference that is caused by a transmission by the aggressor on a set of contiguous RBs (e.g., a subband) in a carrier to reception by the victim on the same set of contiguous RBs in the same carrier. Co-channel inter-subband interference refers to interference that is caused by a transmission by the aggressor in a first set of contiguous RBs in a carrier to reception by the victim in a second set of contiguous RBs in the same carrier, where the two contiguous RB sets are do not overlap in frequency.

Typically, adjacent channel interference refers to interference that is from a transmission by the aggressor in a first carrier to reception by the victim in a second carrier, where the first carrier and the second carrier are adjacent carriers.

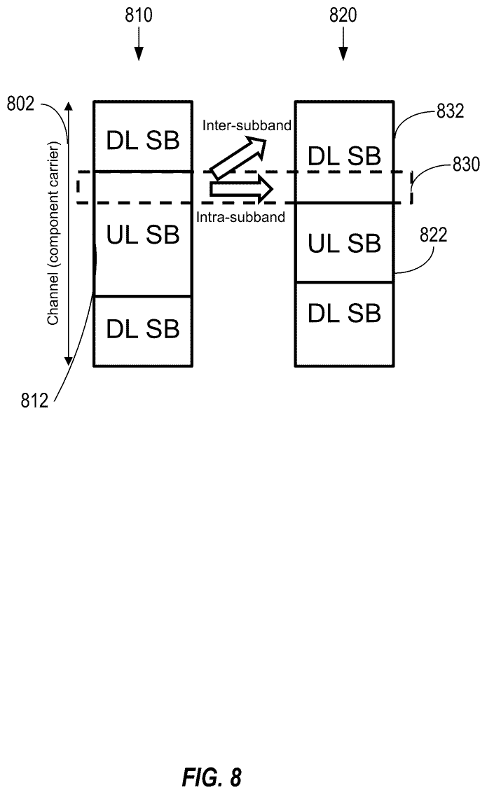

FIG. 8 is a schematic depiction of cross-link interference, in accordance with aspects of the present disclosure. A channel 802 includes a first subband allocation 810 of subbands by a first network entity and a second subband allocation 820 of subbands by a second network entity. Because the UL subband 812 in the first subband allocation is a different size than the UL subband 822 in the second subband allocation, CLI occurs in cells using the two subband allocations. In the set of subbands at 830, the CLI is intra-subband CLI, while in the subbands at 832, the CLI is inter-subband CLI.

In typical communications networks, network entities do not exchange information regarding the subband configurations of cells supported by those network entities. Having information regarding the subband configuration of a neighboring cell may improve the ability of a network entity to perform interference mitigation of CLI.

Accordingly, it is desirable to develop techniques for indicating subband configuration between network entities (e.g., gNBs or DUs) for the purpose of CLI management by the network entities. This indication of subband configuration may be a natural extension of intended TDD configuration indication to subband-specific TDD configurations for subband non-overlapping full duplex operation and subband based half duplex operation.

### Aspects Related to Indicating Subband Configurations Between Network Entities

According to aspects of the present disclosure, techniques for indicating subband configuration between network entities (e.g., gNBs or DUs) are provided. This indication of subband configuration may be used for CLI management by the network entities.

According to aspects of the present disclosure, in order to support SBFD operation in a cell, a network entity (e.g., BS 102) may receive an indication of at least one of time or frequency locations of at least one uplink (UL) subband or at least one downlink (DL) subband for a cell operating with subband full duplex (SBFD) communications or subband half duplex communications. The network entity may then perform interference mitigation (IM) while receiving an UL transmission, based on the indication.

In aspects of the present disclosure, IM by a network entity may include changing a DL and UL subband configuration for a cell so that the DL and UL subband configuration is aligned with a subband configuration of a neighbor cell. When the DL and UL subband configuration is aligned between cells, then there will be no intra-subband CLI, and CLI will be limited to inter-subband CLI, which can be reduced by the use of filters tuned to the subbands in use. IM by a network entity may also include configuring subband half duplex communications, instead of SBFD communications, which may prevent the occurrence of CLI. Configuring subband half duplex communications may be useful in situations in which inter-subband CLI is large.

According to aspects of the present disclosure, in order to support SBFD operation in a cell, a UE (e.g., UE 104) may receive a configuration of at least one of time or frequency locations of at least one uplink (UL) subband or at least one downlink (DL) subband for a neighbor cell operating with subband full duplex (SBFD) communications or subband half duplex communications. The UE may then transmit an indication of the configuration to a network entity serving the UE.

### Example Operations of Entities in a Communications Network

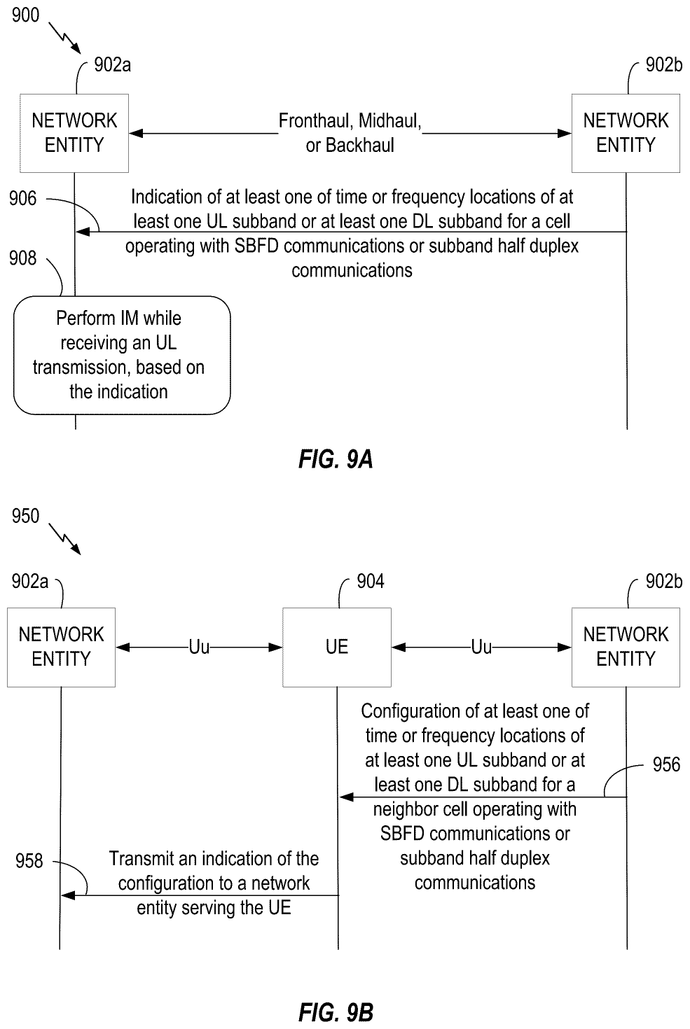

FIG. 9A depicts an example call flow 900 for communications in a network between a first network entity 902a and a second network entity 902b. In some aspects, the network entities 902a and 902b may be examples of the BS 102 depicted and described with respect to FIGS. 1 and 3 or a disaggregated base station depicted and described with respect to FIG. 2. However, in other aspects network entities 902 may be other types of network entities or network nodes, such as those described herein.

At 906, the network entity 902b transmits, and the network entity 902a receives, an indication of at least one of time or frequency locations of at least one uplink (UL) subband or at least one downlink (DL) subband for a cell operating with subband full duplex (SBFD) communications or subband half duplex communications. At 908, the network entity 902a performs interference mitigation (IM) while receiving an UL transmission, based on the indication. For example, the network entity may perform interference mitigation to reduce CLI associated with a DL signal from another cell while receiving an UL transmission from a UE. Performing IM may include changing a DL and UL subband configuration for a cell so that the DL and UL subband configuration is aligned with a subband configuration of a neighbor cell or configuring subband half duplex communications, instead of SBFD communications, which may prevent the occurrence of CLI.

FIG. 9B depicts an example call flow 950 for communications in a network between a first network entity 902a, a second network entity 902b, and a UE 904. In some aspects, the network entities 902a and 902b may be examples of the BS 102 depicted and described with respect to FIGS. 1 and 3 or a disaggregated base station depicted and described with respect to FIG. 2. Similarly, the UE 904 may be an example of UE 104 depicted and described with respect to FIGS. 1 and 3. However, in other aspects, UE 104 may be another type of wireless communications device and BS 102 may be another type of network entity or network node, such as those described herein.

At 956, the network entity 902b transmits, and the UE 904 receives, a configuration of at least one of time or frequency locations of at least one uplink (UL) subband or at least one downlink (DL) subband for a neighbor cell operating with subband full duplex (SBFD) communications or subband half duplex communications. At 958, the UE 904 transmits, and the network entity 902a receives, an indication of the configuration to a network entity serving the UE. For example, the UE 904 may receive, from network entity 902b, a configuration of frequency locations of an UL subband and a DL subband for a neighbor cell operating with SBFD communications. In the example, the UE 904 may transmit an indication of the configuration (of the frequency locations of the neighbor cell) to the network entity 902a that is serving the UE 904. The network entity 902a may then perform interference mitigation as described above at 908 in FIG. 9A.

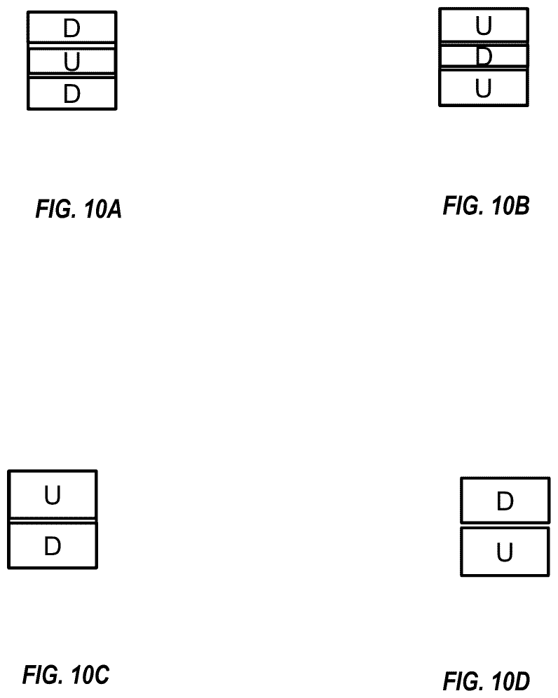

FIGS. 10A, 10B, 10C, and 10D depict example subband frequency configuration patterns that do not include flexible subbands, in accordance with aspects of the present disclosure. FIG. 10A depicts an example D/U/D subband frequency pattern. FIG. 10B depicts an example U/D/U subband frequency pattern. FIG. 10C depicts an example U/D subband frequency pattern. FIG. 10D depicts an example D/U subband frequency pattern. While each of the depicted example frequency patterns shows subbands of approximately equal size, the present disclosure is not so limited, and subbands of different sizes can be allocated within a component carrier. The example subband frequency patterns may be referred to by a network entity or UE when the network entity or UE transmits or receives an indication of at least one of time or frequency locations of at least one UL subband or at least one DL subband for a cell operating with subband full duplex (SBFD) communications or subband half duplex communications, as described above with reference to 906, 956, and 958 in FIGS. 9A and 9B. For example, a first network entity may send (e.g., via a backhaul connection) a list of three sets of RBs and a reference to the D/U/D subband frequency pattern for a cell to a second network entity, and the second network entity may determine that the first set of RBs is a DL subband for the cell, the second set of RBs is an UL subband for the cell, and the third set of RBs is another DL subband for the cell.

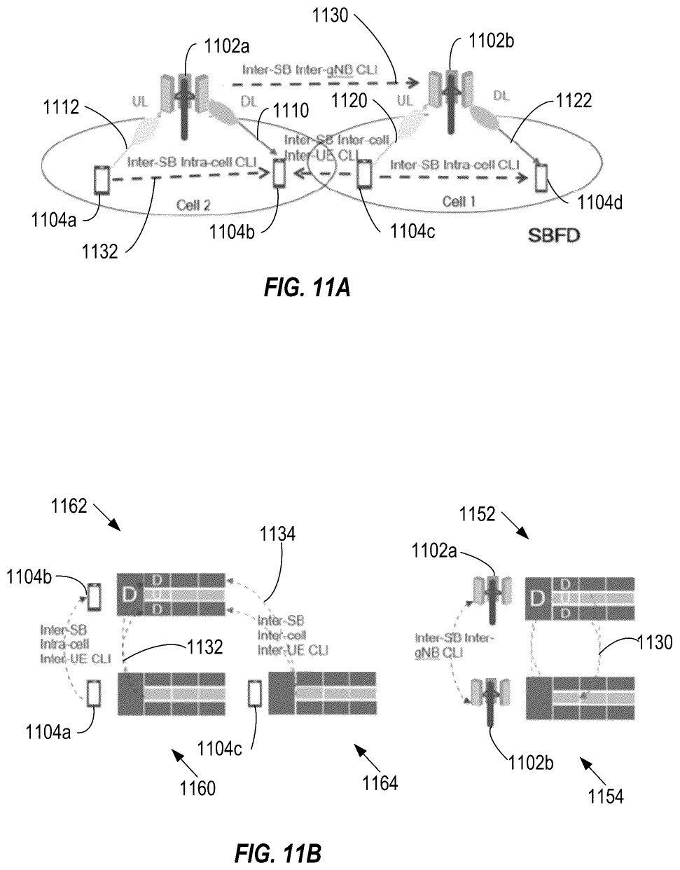

FIG. 11A depicts examples of network entities 1102a and 1102b and UEs 1104a, 1104b, 1104c, and 1104d operating with SBFD communications, in accordance with aspects of the present disclosure. The example network entity 1102a operates cell 2, and the example network entity 1102b operates cell 1. The two cells are synchronized in time. The two cells are operating with TDD, and have configured the next four slots to be DL-only, SBFD, SBFD, and SBFD (see also FIG. 11B). The network entity 1102a configures UL and DL subbands for use in the second, third, and fourth slots in cell 2. If cell 1 configures different UL and DL subbands in the second, third, and fourth slots, then there may be severe CLI between the network entities and/or the UEs.

In aspects of the present disclosure, network entity 1102a sends an indication of the configured UL and DL subbands for cell 2 (e.g., as shown at 906 in FIG. 9A) to network entity 1102b. Upon receiving the indication of the configured UL and DL subbands for cell 2, network entity 1102b performs IM, based on the indication (e.g., as shown at 908 in FIG. 9A). For example, network entity 1102b configures cell 1 with the same UL and DL subbands in the SBFD communications in the second, third, and fourth slots (see also FIG. 11B). By configuring cell 1 to use the same UL and DL subbands as those used in cell 2, network entity 1102b eliminates the possibility of intra-subband CLI. During the second slot, network entity 1102a schedules a downlink transmission 1110 to UE 1104b and an uplink transmission 1112 from UE 1104a. During the second slot, network entity 1102b schedules an UL transmission 1120 from UE 1104c and a DL transmission 1122 to UE 1104d. Inter-cell CLI associated with the DL transmission 1110 is shown at 1130. Inter-UE inter-subband (inter-SB) intra-cell CLI associated with the UL transmission 1112 is shown at 1132. Inter-UE inter-SB inter-cell CLI associated with the UL transmission 1120 is shown at 1134. Thus, while there is both inter-cell and intra-cell inter-UE cross-link interference and inter-gNB cross-link interference, because network entity 1102b received the indication of the UL and DL subbands from network entity 1102a and performed IM by configuring UL and DL subbands in cell 1 to match the UL and DL subbands in cell 2, all of the interference is inter-subband interference, and intra-subband CLI is mitigated.

FIG. 11B depicts example timeline 1152 of cell 1, timeline 1154 of cell 2, timeline 1160 of UE 1104a, timeline 1162 of UE 1104b, and timeline 1164 of UE 1104c, in accordance with aspects of the present disclosure. During the second slot 1170, network entity 1102a configures two DL subbands and an UL subband. Thus, cell 1 operates with SBFD communications during the second slot 1170. Similarly, during the second slot 1170, network entity 1102b configures two DL subbands and an UL subband in the same frequency bands as the subbands configured by network entity 1102a. Thus, cell 2 also operates with SBFD communications during the flexible slot 1260.

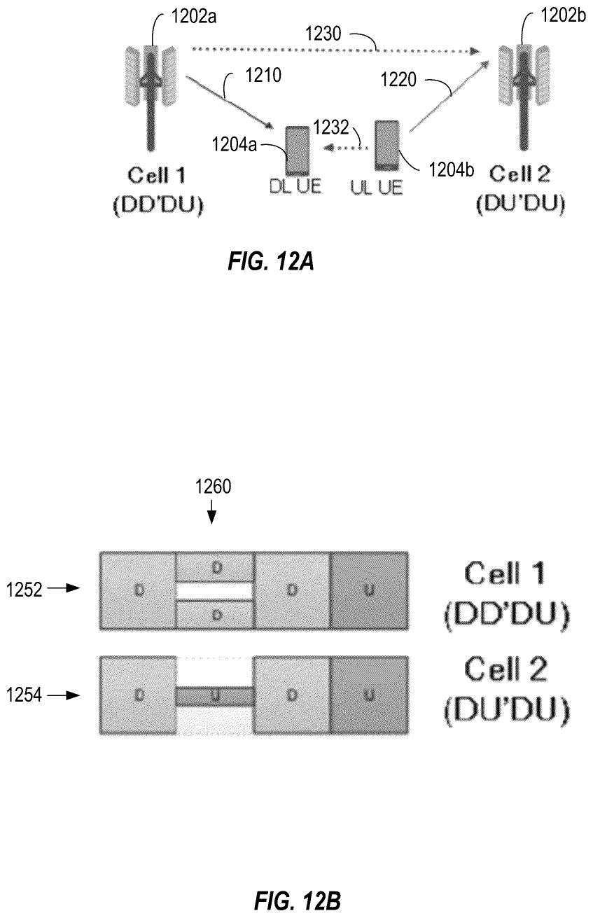

FIG. 12A depicts an example of two network entities 1202a and 1202b and two UEs 1204a and 1204b operating with subband half duplex communications, in accordance with aspects of the present disclosure. The example network entity 1202a operates cell 1, and the example network entity 1202b operates cell 2. The two cells are synchronized in time. The two cells are operating with TDD, and have configured the next four slots to be DL, subband half duplex, DL, and UL (see also FIG. 12B). During the flexible slot, network entity 1202a schedules a downlink transmission 1210 to UE 1204a. During the subband half duplex slot, network entity 1202b schedules an UL transmission 1220 from UE 1204b. Inter-cell CLI associated with the DL transmission 1210 is shown at 1230. Inter-UE CLI associated with the UL transmission 1220 is shown at 1232.

FIG. 12B depicts example timeline 1252 of cell 1 and example timeline 1254 of cell 2, in accordance with aspects of the present disclosure. During the flexible slot 1260, network entity 1202a configures two DL subbands while leaving the central subband unconfigured. Thus, cell 1 operates with subband half duplex communications during the flexible slot 1260. Similarly, during the flexible slot 1260, network entity 1202b configures an UL subband while leaving the two outer subbands unconfigured. Thus, cell 2 also operates with subband half duplex communications during the flexible slot 1260.

According to aspects of the present disclosure, a CU may indicate the DL and UL subband configuration of a first DU or gNB to a second DU or gNB. For example, an operator may control two gNBs that belong to a same CU, and the CU may indicate the DL and UL subband configuration of one gNB to the other gNB. The second DU or gNB receiving the DL and UL subband configuration from the CU may be an example of receiving an indication of at least one of time or frequency locations of at least one uplink (UL) subband or at least one downlink (DL) subband for a cell operating with subband full duplex (SBFD) communications or subband half duplex communications, as shown at 906 in FIG. 9A.

In aspects of the present disclosure, a first CU may indicate the DL and UL subband configuration of a first DU or gNB controlled by the first CU to a second CU. The second CU may forward this subband configuration to a second DU or gNB controlled by the second CU. For example, inter-operator gNBs belong to different CUs belonging to different operators may share DL and UL subband configurations. The second DU or gNB receiving the DL and UL subband configuration from the second CU may be an example of receiving an indication of at least one of time or frequency locations of at least one uplink (UL) subband or at least one downlink (DL) subband for a cell operating with subband full duplex (SBFD) communications or subband half duplex communications, as shown at 906 in FIG. 9A.

According to aspects of the present disclosure, a first DU may indicate a DL and UL subband configuration used by the first DU to a second DU via over-the-air (OTA) signaling. The second DU receiving the DL and UL subband configuration from the first DU may be an example of receiving an indication of at least one of time or frequency locations of at least one uplink (UL) subband or at least one downlink (DL) subband for a cell operating with subband full duplex (SBFD) communications or subband half duplex communications, as shown at 906 in FIG. 9A.

In aspects of the present disclosure, a UE can report the DL and UL subband configuration information of a neighbor cell or neighbor gNB received from that neighbor cell or neighbor gNB via broadcast signaling (e.g., in a system information block (SIB)), if the DL and UL subband configuration is different from a DL and UL subband configuration of a serving cell or gNB of the UE. The UE receiving the configuration of the neighbor cell or neighbor gNB may be an example of receiving a configuration of at least one of time or frequency locations of at least one uplink (UL) subband or at least one downlink (DL) subband for a neighbor cell operating with subband full duplex (SBFD) communications or subband half duplex communications, as shown at 956 in FIG. 9B. The UE reporting the DL and UL subband configuration information of a neighbor cell or neighbor gNB may be an example of transmitting an indication of the configuration to a network entity serving the UE, as shown at 958 in FIG. 9B. The serving cell or gNB receiving the configuration from the UE may be an example of receiving an indication of at least one of time or frequency locations of at least one uplink (UL) subband or at least one downlink (DL) subband for a cell operating with subband full duplex (SBFD) communications or subband half duplex communications, as shown at 906 in FIG. 9A.

According to aspects of the present disclosure, a network entity receiving such a report of a subband configuration of a neighbor cell from a served UE may, based on such a UE report, then negotiate with the neighbor cell or gNB regarding aligning a subband configuration of the network entity with the subband configuration of the neighbor cell or gNB, in order to reduce intra-SB interference.

### Example Operations of a User Equipment

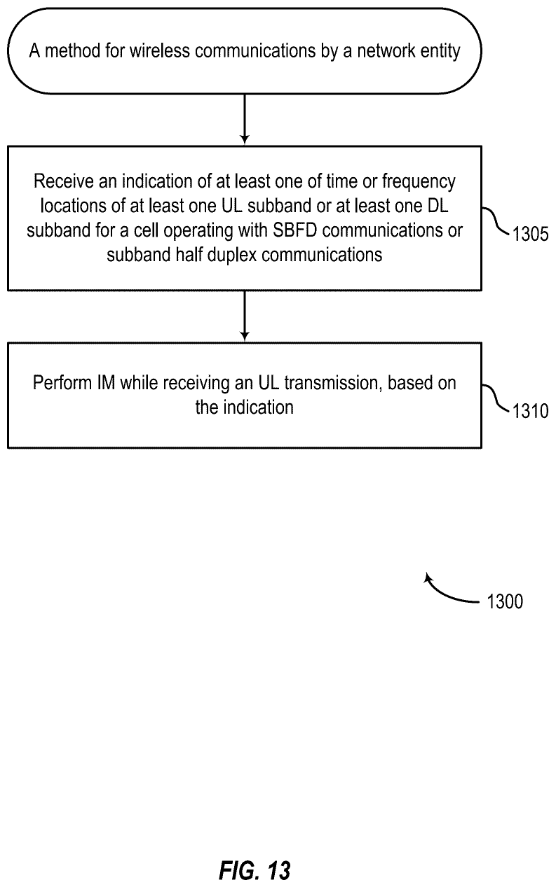

FIG. 13 shows an example of a method 1300 for wireless communications by a network entity, such as a BS 102 of FIGS. 1 and 3, or a disaggregated base station as discussed with respect to FIG. 2.

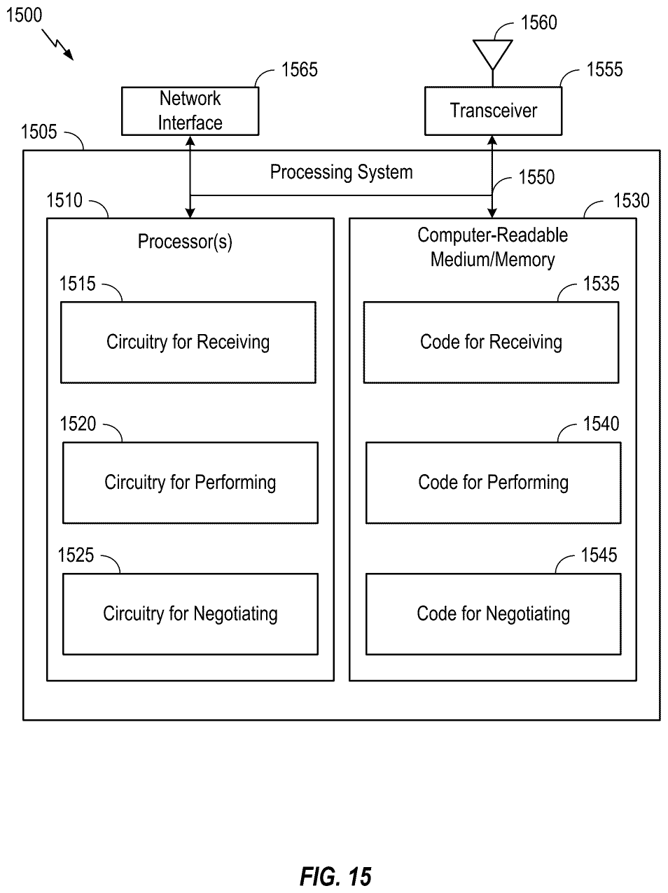

Method 1300 begins at step 1305 with receiving an indication of at least one of time or frequency locations of at least one UL subband or at least one DL subband for a cell operating with SBFD communications or subband half duplex communications. In some cases, the operations of this step refer to, or may be performed by, circuitry for receiving and/or code for receiving as described with reference to FIG. 15.

Method 1300 then proceeds to step 1310 with performing IM while receiving an UL transmission, based on the indication. In some cases, the operations of this step refer to, or may be performed by, circuitry for performing and/or code for performing as described with reference to FIG. 15.

In some aspects, the IM is performed to mitigate CLI while receiving the UL transmission.

In some aspects, the CLI comprises at least one of inter-subband CLI and intra-subband CLI.

In some aspects, the CLI comprises at least one of inter-gNB CLI or inter-UE CLI.

In some aspects, the network entity comprises a DU; the indication is received from a CU of the DU; and the cell is operated by another DU associated with the CU.

In some aspects, the network entity comprises a first DU associated with a first CU; the cell is operated by a second DU associated with a second CU; and the indication is received from the second CU via the first CU.

In some aspects, the network entity comprises a first DU; the cell is operated by a second DU; and the indication is received via an OTA signal directed to the first DU from the second DU.

In some aspects, the network entity comprises a first DU; the cell is operated by a second DU; and the indication is received from a UE served by the first DU.

In some aspects, the indication is based on a SIB received by the UE.

In some aspects, the method 1300 further includes negotiating with the second DU regarding a SBFD configuration for the first DU. In some cases, the operations of this step refer to, or may be performed by, circuitry for negotiating and/or code for negotiating as described with reference to FIG. 15.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Operations of a User Equipment

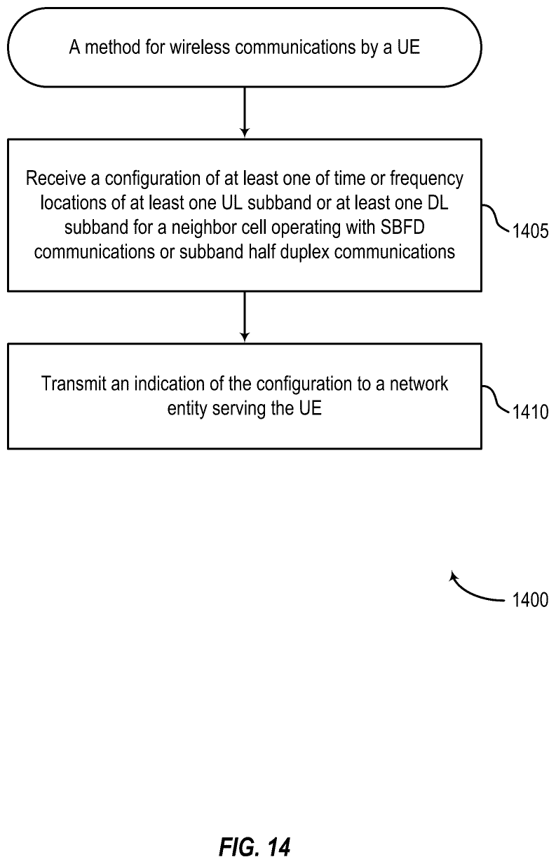

FIG. 14 shows an example of a method 1400 for wireless communications by a UE, such as a UE 104 of FIGS. 1 and 3.

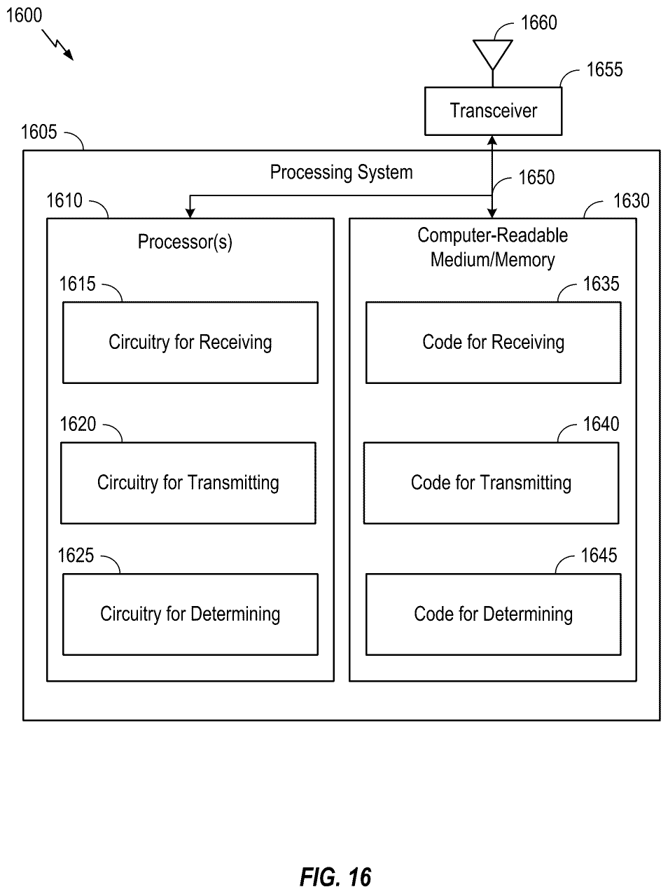

Method 1400 begins at step 1405 with receiving a configuration of at least one of time or frequency locations of at least one UL subband or at least one DL subband for a neighbor cell operating with SBFD communications or subband half duplex communications. In some cases, the operations of this step refer to, or may be performed by, circuitry for receiving and/or code for receiving as described with reference to FIG. 16.

Method 1400 then proceeds to step 1410 with transmitting an indication of the configuration to a network entity serving the UE. In some cases, the operations of this step refer to, or may be performed by, circuitry for transmitting and/or code for transmitting as described with reference to FIG. 16.

In some aspects, the configuration is received in a SIB.

In some aspects, the UE is being served by a cell operating with SBFD communications. In some aspects, the method 1400 further includes determining to transmit the indication based on a comparison of the configuration with another configuration for the cell serving the UE, wherein the other configuration includes at least one of other time or other frequency locations of at least one of another DL subband or another UL subband. In some cases, the operations of this step refer to, or may be performed by, circuitry for determining and/or code for determining as described with reference to FIG. 16.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

### Example Communications Devices

FIG. 15 depicts aspects of an example communications device 1500. In some aspects, communications device 1500 is a network entity, such as a BS 102 of FIGS. 1 and 3, or a disaggregated base station as discussed with respect to FIG. 2.

The communications device 1500 includes a processing system 1505 coupled to the transceiver 1555 (e.g., a transmitter and/or a receiver) and/or a network interface 1565. The transceiver 1555 is configured to transmit and receive signals for the communications device 1500 via the antenna 1560, such as the various signals as described herein. The network interface 1565 is configured to obtain and send signals for the communications device 1500 via communication link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1530 via a bus 1550. In certain aspects, the computer-readable medium/memory 1530 is configured to store instructions (e.g., computer-executable code) that when executed by the one or more processors 1510, cause the one or more processors 1510 to perform the method 1300 described with respect to FIG. 13, or any aspect related to it. Note that reference to a processor of communications device 1500 performing a function may include one or more processors 1510 of communications device 1500 performing that function.

In the depicted example, the computer-readable medium/memory 1530 stores code (e.g., executable instructions), such as code for receiving 1535, code for performing 1540, and code for negotiating 1545. Processing of the code for receiving 1535, code for performing 1540, and code for negotiating 1545 may cause the communications device 1500 to perform the method 1300 described with respect to FIG. 13, or any aspect related to it.

The one or more processors 1510 include circuitry configured to implement (e.g., execute) the code stored in the computer-readable medium/memory 1530, including circuitry such as circuitry for receiving 1515, circuitry for performing 1520, and circuitry for negotiating 1525. Processing with circuitry for receiving 1515, circuitry for performing 1520, and circuitry for negotiating 1525 may cause the communications device 1500 to perform the method 1300 as described with respect to FIG. 13, or any aspect related to it.

Various components of the communications device 1500 may provide means for performing the method 1300 as described with respect to FIG. 13, or any aspect related to it. Means for transmitting, sending or outputting for transmission may include transceivers 332 and/or antenna(s) 334 of the BS 102 illustrated in FIG. 3 and/or the transceiver 1555 and the antenna 1560 of the communications device 1500 in FIG. 15. Means for receiving or obtaining may include transceivers 332 and/or antenna(s) 334 of the BS 102 illustrated in FIG. 3 and/or the transceiver 1555 and the antenna 1560 of the communications device 1500 in FIG. 15.

FIG. 16 depicts aspects of an example communications device 1600. In some aspects, communications device 1600 is a user equipment, such as a UE 104 described above with respect to FIGS. 1 and 3.

The communications device 1600 includes a processing system 1605 coupled to the transceiver 1655 (e.g., a transmitter and/or a receiver). The transceiver 1655 is configured to transmit and receive signals for the communications device 1600 via the antenna 1660, such as the various signals as described herein. The processing system 1605 may be configured to perform processing functions for the communications device 1600, including processing signals received and/or to be transmitted by the communications device 1600.

The processing system 1605 includes one or more processors 1610. In various aspects, the one or more processors 1610 may be representative of one or more of receive processor 358, transmit processor 364, TX MIMO processor 366, and/or controller/processor 380, as described with respect to FIG. 3. The one or more processors 1610 are coupled to a computer-readable medium/memory 1630 via a bus 1650. In certain aspects, the computer-readable medium/memory 1630 is configured to store instructions (e.g., computer-executable code) that when executed by the one or more processors 1610, cause the one or more processors 1610 to perform the method 1400 described with respect to FIG. 14, or any aspect related to it. Note that reference to a processor performing a function of communications device 1600 may include one or more processors 1610 performing that function of communications device 1600.

In the depicted example, computer-readable medium/memory 1630 stores code (e.g., executable instructions), such as code for receiving 1635, code for transmitting 1640, and code for determining 1645. Processing of the code for receiving 1635, code for transmitting 1640, and code for determining 1645 may cause the communications device 1600 to perform the method 1400 described with respect to FIG. 14, or any aspect related to it.

The one or more processors 1610 include circuitry configured to implement (e.g., execute) the code stored in the computer-readable medium/memory 1630, including circuitry such as circuitry for receiving 1615, circuitry for transmitting 1620, and circuitry for determining 1625. Processing with circuitry for receiving 1615, circuitry for transmitting 1620, and circuitry for determining 1625 may cause the communications device 1600 to perform the method 1400 described with respect to FIG. 14, or any aspect related to it.

Various components of the communications device 1600 may provide means for performing the method 1400 described with respect to FIG. 14, or any aspect related to it. For example, means for transmitting, sending or outputting for transmission may include transceivers 354 and/or antenna(s) 352 of the UE 104 illustrated in FIG. 3 and/or the transceiver 1655 and the antenna 1660 of the communications device 1600 in FIG. 16. Means for receiving or obtaining may include transceivers 354 and/or antenna(s) 352 of the UE 104 illustrated in FIG. 3 and/or the transceiver 1655 and the antenna 1660 of the communications device 1600 in FIG. 16.

### Example Clauses

Implementation examples are described in the following numbered clauses:

Clause 1: A method for wireless communications by a network entity, comprising: receiving an indication of at least one of time or frequency locations of at least one UL subband or at least one DL subband for a cell operating with SBFD communications or subband half duplex communications; and performing IM while receiving an UL transmission, based on the indication.

Clause 2: The method of Clause 1, wherein the IM is performed to mitigate CLI while receiving the UL transmission.

Clause 3: The method of Clause 2, wherein the CLI comprises at least one of inter-subband CLI and intra-subband CLI.

Clause 4: The method of Clause 2, wherein the CLI comprises at least one of inter-gNB CLI or inter-UE CLI.

Clause 5: The method of any one of Clauses 1-4, wherein: the network entity comprises a DU; the indication is received from a CU of the DU; and the cell is operated by another DU associated with the CU.

Clause 6: The method of any one of Clauses 1-5, wherein: the network entity comprises a first DU associated with a first CU; the cell is operated by a second DU associated with a second CU; and the indication is received from the second CU via the first CU.

Clause 7: The method of any one of Clauses 1-6, wherein: the network entity comprises a first DU; the cell is operated by a second DU; and the indication is received via an OTA signal directed to the first DU from the second DU.

Clause 8: The method of any one of Clauses 1-7, wherein: the network entity comprises a first DU; the cell is operated by a second DU; and the indication is received from a UE served by the first DU.

Clause 9: The method of Clause 8, wherein the indication is based on a SIB received by the UE.

Clause 10: The method of Clause 8, further comprising: negotiating with the second DU regarding a SBFD configuration for the first DU.

Clause 11: A method for wireless communications by a UE, comprising: receiving a configuration of at least one of time or frequency locations of at least one UL subband or at least one DL subband for a neighbor cell operating with SBFD communications or subband half duplex communications; and transmitting an indication of the configuration to a network entity serving the UE.

Clause 12: The method of Clause 11, wherein the configuration is received in a SIB.

Clause 13: The method of any one of Clauses 11-12, wherein the UE is being served by a cell operating with SBFD communications, and the method further comprises: determining to transmit the indication based on a comparison of the configuration with another configuration for the cell serving the UE, wherein the other configuration includes at least one of other time or other frequency locations of at least one of another DL subband or another UL subband.

Clause 14: An apparatus, comprising: a memory comprising executable instructions; and a processor configured to execute the executable instructions and cause the apparatus to perform a method in accordance with any one of Clauses 1-13.

Clause 15: An apparatus, comprising means for performing a method in accordance with any one of Clauses 1-13.

Clause 16: A non-transitory computer-readable medium comprising executable instructions that, when executed by a processor of an apparatus, cause the apparatus to perform a method in accordance with any one of Clauses 1-13.

Clause 17: A computer program product embodied on a computer-readable storage medium comprising code for performing a method in accordance with any one of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A network entity configured for wireless communication, comprising: a memory comprising computer-executable instructions; and one or more processors configured to execute the computer-executable instructions and cause the network entity to:
receive an indication of at least one of time or frequency locations of at least one uplink (UL) subband or at least one downlink (DL) subband for a cell operating with subband full duplex (SBFD) communications or subband half duplex communications; and
perform interference mitigation (IM) while receiving an UL transmission, based on the indication.

2. The network entity of claim 1, wherein the processor is configured to execute the computer-executable instructions and further cause the network entity to perform the IM to mitigate cross link interference (CLI) while receiving the UL transmission.

3. The network entity of claim 2, wherein the CLI comprises at least one of inter-subband CLI and intra-subband CLI.

4. The network entity of claim 2, wherein the CLI comprises at least one of inter-gNodeB (inter-gNB) CLI or inter-user equipment (inter-UE) CLI.

5. The network entity of claim 1, wherein:
the network entity comprises a distributed unit (DU);
the processor is configured to execute the computer-executable instructions and further cause the network entity to receive the indication from a central unit (CU) of the DU; and
the cell is operated by another DU associated with the CU.

6. The network entity of claim 1, wherein:
the network entity comprises a first distributed unit (DU) associated with a first central unit (CU);
the cell is operated by a second DU associated with a second CU; and
the processor is configured to execute the computer-executable instructions and further cause the network entity to receive the indication from the second CU via the first CU.

7. The network entity of claim 1, wherein:
the network entity comprises a first distributed unit (DU);
the cell is operated by a second DU; and
the processor is configured to execute the computer-executable instructions and further cause the network entity to receive the indication via an over-the-air (OTA) signal directed to the first DU from the second DU.

8. The network entity of claim 1, wherein:
the network entity comprises a first distributed unit (DU);
the cell is operated by a second DU; and
the processor is configured to execute the computer-executable instructions and further cause the network entity to receive the indication from a user equipment (UE) served by the first DU.

9. The network entity of claim 8, wherein the indication is based on a system information block (SIB) received by the UE.

10. The network entity of claim 8, wherein the processor is configured to execute the computer-executable instructions and further cause the network entity to:
negotiate with the second DU regarding a SBFD configuration for the first DU.

11. A user equipment (UE) configured for wireless communication, comprising: a memory comprising computer-executable instructions; and one or more processors configured to execute the computer-executable instructions and cause the UE to:
receive a configuration of at least one of time or frequency locations of at least one uplink (UL) subband or at least one downlink (DL) subband for a neighbor cell operating with subband full duplex (SBFD) communications or subband half duplex communications; and
transmit an indication of the configuration to a network entity serving the UE.

12. The UE of claim 11, wherein the configuration is received in a system information block (SIB).

13. The UE of claim 11, wherein the UE is being served by a cell operating with SBFD communications, and wherein the processor is configured to execute the computer-executable instructions and further cause the UE to:
determine to transmit the indication based on a comparison of the configuration with another configuration for the cell serving the UE, wherein the other configuration includes at least one of other time or other frequency locations of at least one of another DL subband or another UL subband.

14. A method for wireless communications by a network entity, comprising:
receiving an indication of at least one of time or frequency locations of at least one uplink (UL) subband or at least one downlink (DL) subband for a cell operating with subband full duplex (SBFD) communications or subband half duplex communications; and
performing interference mitigation (IM) while receiving an UL transmission, based on the indication.

15. The method of claim 14, wherein the IM is performed to mitigate cross link interference (CLI) while receiving the UL transmission.

16. The method of claim 15, wherein the CLI comprises at least one of inter-subband CLI and intra-subband CLI.

17. The method of claim 15, wherein the CLI comprises at least one of inter-gNodeB (inter-gNB) CLI or inter-user equipment (inter-UE) CLI.

18. The method of claim 14, wherein:
the network entity comprises a distributed unit (DU);
the indication is received from a central unit (CU) of the DU; and
the cell is operated by another DU associated with the CU.

19. The method of claim 14, wherein:
the network entity comprises a first distributed unit (DU) associated with a first central unit (CU);
the cell is operated by a second DU associated with a second CU; and
the indication is received from the second CU via the first CU.

20. The method of claim 14, wherein:
the network entity comprises a first distributed unit (DU);
the cell is operated by a second DU; and
the indication is received via an over-the-air (OTA) signal directed to the first DU from the second DU.

21. The method of claim 14, wherein:
the network entity comprises a first distributed unit (DU);
the cell is operated by a second DU; and
the indication is received from a user equipment (UE) served by the first DU.

22. The method of claim 21, wherein the indication is based on a system information block (SIB) received by the UE.

23. The method of claim 21, further comprising:
negotiating with the second DU regarding a SBFD configuration for the first DU.

24. A method for wireless communications by a user equipment (UE), comprising:
receiving a configuration of at least one of time or frequency locations of at least one uplink (UL) subband or at least one downlink (DL) subband for a neighbor cell operating with subband full duplex (SBFD) communications or subband half duplex communications; and
transmitting an indication of the configuration to a network entity serving the UE.

25. The method of claim 24, wherein the configuration is received in a system information block (SIB).

26. The method of claim 24, wherein the UE is being served by a cell operating with SBFD communications, and the method further comprises:
determining to transmit the indication based on a comparison of the configuration with another configuration for the cell serving the UE, wherein the other configuration includes at least one of other time or other frequency locations of at least one of another DL subband or another UL subband.
